(19) United States
(12) Patent Application Publication
(10) Pub. No.: US 2017/0247044 A1
(43) Pub. Date: Aug. 31, 2017

(54) SEAT FOR A PUSHCHAIR AND/OR DOLL'S PRAM

(71) Applicant: CURT WUERSTL VERMOEGENSVERWALTUNGS-GMBH & CO. KG, Hof (DE)

(72) Inventor: Jan-Stefan Wuerstl, Regnitzlosau (DE)

(21) Appl. No.: 15/519,511

(22) PCT Filed: Oct. 20, 2015
(86) PCT No.: PCT/EP2015/074232

§ 371 Date: Apr. 14, 2017

(30) Foreign Application Priority Data
Oct. 22, 2014 (DE) 20 2014 105 063.9

(51) Int. Cl. B62B 9/10; B62B 7/12

(52) U.S. Cl. CPC B62B 9/104; B62B 7/123

(57) ABSTRACT

Disclosed is a seat for a pushchair and/or for a doll's pram, in which a coupling unit is arranged between the back rest and the leg rest, the coupling unit carrying out an opposite movement transformation of the leg rest synchronous or offset in time when lowering the backrest, and the leg rest is moved back into the lower pivot position when the back rest is raised or is released for putting back in place.

The present invention relates to a seat, which is constructed to be anchored to, in particular, a pushchair frame and/or doll's pram frame, comprising at least a seat element, a backrest, the inclination of which is formed to be variable along a first pivot axis by way of a pivot mechanism so as to bring the seat from a seating position a lying position or conversely, and a leg support for supporting the legs, which is pivotably connected with the seat element to be pivotable about a further pivot axis.

Seats of that kind are known from the prior art, which frequently prove disadvantageous for, in particular, pushchairs. Current seats are disadvantageous particularly for active small children, since the backrest has to be manually adjusted separately from the leg support. It is thus correspondingly difficult for parents to bring the seat from an upright seating position into a lying position, since initially they manually fold the backrest rearwardly in order to subsequently then bring the leg support into a substantially horizontal orientation so that the child can sleep comfortably and safely. In addition, in known seats there is the problem that children secured by safety belts have to be unstrapped when bringing into the lying position, as otherwise the belt across the rib cage can lead to crushing and injury.

On this basis the present invention has the object of providing a seat which can be brought simply and without complication from a seating position to a lying position or conversely. In addition, the present invention has the object of providing a seat which is constructed to be comfortable and safe for, in particular, small children without these having to be unstrapped when changing the seating position.

The core concept of the present invention consists of providing between the backrest and the leg support of a seat of the relevant kind a coupling unit which when the backrest is lowered produces a movement transformation of the leg support in opposite sense synchronously or with a displacement in time and when the backrest is erected restores the leg support to the lower pivot setting or frees it for resetting.

According to the invention a constrained movement transformation or, however, a movement transformation displaced in time can be provided between the backrest and the leg support. For constrained movement transformation, for example, a rod-shaped connecting element can be pivotably connected with at least one entrainer at the lower side of the backrest in the region of the pivot axis at the seat element and with at least one entrainer at the lower side of the leg support. It will be evident that when the backrest is pivoted the leg support is automatically pivoted therewith in known mode and manner. The entrainer can be a bracket secured to the rear side of the backrest in the region of the pivot axis at the seat element, the bracket having a mounting bore for reception of the bearing pin at the rod-shaped connecting element. The second entrainer can be mounted at a longitudinal post of the leg support. The second end of the rod-shaped connecting element is pivotably connected with this entrainer.

This same way of attaching can also be selected when a connecting element variable in the length thereof is provided so as to cause erection of the leg support to be delayed in time by comparison with the movement of the backrest. The connecting element consists of a telescopic tube which when the erected backrest is lowered initially shortens by a defined amount before, through further lowering, the connecting element erects the leg support. It will be evident that when the backrest is erected again the connecting element automatically lengthens once more; thus lowering of the leg support is delayed, before the telescopic rod lowers the leg support in constrained synchronism with the remaining angular adjustment of the backrest.

It is known for fixing the backrest to provide a detentable pivot axle at the seat element or to provide, in the side parts of the seat element, discoid segments with detent teeth or detent recesses for sliding in of locking projections at the side bearers of the backrest. The backrest can thereby adopt different inclined settings. However, it is also possible to hold the backrest by a yoke which at the same time can also be a component of a foldable sunshade or protective roof for the seat. This yoke can be separately pivotably mounted at the side members and, for example, also engage behind the backrest. Locking in the different inclined settings can be ensured by way of appropriately constructed bearings at the side members of the seat element.

It has proved advantageous to provide a coupling unit of that kind between backrest and leg support, since the coupling unit in the case of application of force to the backrest for transfer from a seating position to a lying position is sufficient to be able to advantageously bring the leg support at the same time, thus synchronously therewith, from the previous substantially vertically oriented seating position to a substantially horizontally oriented lying position. Laborious pivotation of the backrest and leg support in succession is eliminated. Thus, the coupling unit enables pivotation of backrest and leg support merely by a single manoeuvre. This represents a substantial simplification for parents. Depending on the respective form of embodiment it is conceivable to make this single necessary manoeuvre possible by application of pressure force to the backrest.

Further advantageous forms of embodiment are evident from the subclaims.

In a further advantageous form of embodiment the at least one connecting element variable in the length thereof is arranged below the seat element. This is of advantage, since the connecting element thus does not have to be disruptively provided in the seat or seat element itself, but advantageously is provided below the seat element—which with advantage is constructed as a seating surface—and at a spacing therefrom. The embodiment in which the connecting element is variable in its length has proved convenient in that respect since the coupling of the movement of the backrest and leg support can thus be realised with only a few components.

In a further advantageous form of embodiment the connecting element is of multi-part construction, advantageously of multi-part rod-like construction. It has proved advantageous for the connecting element to be composed of at least two rod elements, which are preferably constructed to be tubular as a round tube or square tube or particularly advantageously as telescopic tubes engaging one in the other, so that the connecting element is itself variable in its length by engagement of the telescopic rod elements one in the other.

In addition, the telescopic rod-like construction of the connecting element is a space-saving arrangement at the seat itself. As a result, an individual setting between the upright seating position and the horizontal lying position can additionally be undertaken.

In a further advantageous form of embodiment the at least one connecting element is constructed to be non-variable in the length thereof when a pressure force is applied to the backrest and/or is constructed to be variable in the length thereof when a tension force is applied to the backrest.

This division of force is particularly advantageous. If the seat is to be initially brought from the seating position to the lying position the backrest is acted on by a pressure force so that this is deflected from its original seating position. By virtue of the coupling unit, the at least one connecting element advantageously similarly undergoes at the same time a loading with pressure force and is deflected from its initial position in the direction of the leg support. In that case, the connecting element does not change its length. The pressure force is consequently passed on to the leg support so that this is deflected about a pivot axis out of the seating position.

For transfer to the lying position it is thus of advantage if the at least one connecting element is constructed to be non-variable in the length thereof. With particular advantage, the deflection of the backrest and leg support takes place synchronously with respect to one another. By synchronous there is advantageously to be understood a simultaneous course of movement.

In one form of embodiment, the leg support and backrest are additionally coupled for subsequent return transfer from the lying position to the seating position, so that the application of tension force to the backrest erects this again and thus also restores the leg support back to the seating position. In this example, the at least one connecting element remains unchanged in its length.

Moreover, it has proved advantageous that when change in the length of the at least one connecting element takes place, particularly advantageously when increase in the length occurs, the leg support remains in the lying position while the backrest is returned from the lying position to the seating position. In this case the movement sequence is decoupled so that return pivotation of the backrest from the lying position to the seating position takes place independently of the position of the leg support, which, for example, remains in the lying position. The seat element advantageously remains undeflected not only during bringing of the seat into lying position, but also back again into the seating position.

In a further advantageous form of embodiment the backrest comprises at least one projection, which extends in longitudinal direction of the backrest, as part of the coupling unit, wherein the projection extends beyond at least one end of the backrest. This is of advantage, since a simple and economic lengthening of the backrest is thereby made possible. In the simplest case the free end of the projection is constructed to be straight. Obviously, this is not to be understood as limiting, so that it is also conceivable, for example, for the free end of the projection to be formed to be convexly and/or concavely curved. It has proved advantageous for force distribution and stability to provide two projections of that kind at the rear side, thus the outer side. The projections are constructed from metal, for example aluminium, and/or plastics material.

In a further advantageous form of embodiment the respective free end of the projection co-operates with a free end of the connecting element so that, as a result, an upstream lever axis is formed. This lever axis extends at least partly between the two free ends of the projections perpendicularly to the length direction of the backrest. If a pressure force is applied to the backrest, then this initially undergoes deflection about the direct pivot axis formed between seat element and backrest. A further axis, which is formed as an upstream lever axis, arises through the prolonged construction of the projections at the rear side of the backrest and the coupling thereof to the at least one connecting element below the seat element, in which case the at least one connecting element is arranged at a spacing from the seat element advantageously in a range of 2 centimetres to 15 centimetres, still more advantageously in the range of 4 centimetres to 8 centimetres (seating position). By upstream in this context it is advantageously to be understood that the lever axis is upstream of the actual pivot axis of the backrest. This upstream position makes possible, in simple and advantageous manner, direct coupling and/or also decoupling of backrest and leg support, as already described above.

In a further advantageous form of embodiment the lever axis is arranged below the seat element and/or behind the backrest. This is advantageous, since the lever axis is thus formed to be offset relative to the seat element and offset relative to the backrest. This makes possible a light and simplified guidance of the leg support into the lying position. In addition, this offset ensures a permanent and easy capability of pivotation of the backrest. When the backrest is being brought from the seating position to the lying position the lever axis is similarly pivoted therewith, advantageously in the direction of the seating element, so that the at least one telescopic connecting element, in particular, also remains unchanged in its length, but similarly experiences deflection in the direction of the seat element. Advantageously, the spacing between the at least one telescopically constructed connecting element and the seat element and/or between the lever axis and the seat element reduces during transfer of the backrest from the seating position to the lying position.

The upstream lever axis described here additionally proves advantageous for belt guidance. If, for example, a safety belt is provided for the seat illustrated here then this can be guided at least partly perpendicularly to the lever axis and at least partly along it, in which case the safety belt can be brought through openings in the backrest forwardly into the actual seat region so as to secure the child there. If pivotation of the backrest from the seating position to the lying position now takes place, the upstream lever axis and the belt guide pivotably connected therewith ensure that the child when brought into the lying position is comfortably and safely returned without the belt cutting into the neck or arms. The form of embodiment described here is thus advantageously distinguished by the fact that children in the belted-up state can be brought without problems from the seating position to the lying position without suffering injury or damage.

In a further advantageous form of embodiment the leg support is constructed to be decoupled, in the lying position, from the backrest. During transfer to the lying position the movement sequence of the leg support is advantageously coupled with the movement sequence of the backrest. In order to ensure that the leg support also withstands movements of the child when asleep, advantageously a detent mechanism is provided which comprises at least one detent element. The detent mechanism with the at least one detent element ensures that the leg support remains in the substantially horizontal position. Pivotation of the leg support into the lying position up to the horizontal deflection thereof is advantageous, wherein even more advantageously the deflection takes place beyond the horizontal so that the free end of the leg support is arranged to be higher than the seat element. The detent element holds the leg support in the lying position and is advantageously constructed as a pushbutton, pull strap or also spring in such a manner that when the lying position is reached the leg support and/or at least a section of the leg support co-operates or co-operate with the detent mechanism and is or are advantageously engaged under and held by this.

With advantage, this detent mechanism is of stable construction in such a way that the action of tension force on the backrest in order to return this to the seating position is not sufficient to overcome the detent mechanism and the fixing force acting as a result. The detent mechanism retains the leg support in the lying position so that the at least one connecting element is telescopically extended in its length in order to make possible the necessary travel for the upright seating position of the backrest.

In a further advantageous form of embodiment the detent element is arranged on the further pivot axis. This is of advantage for the sake of simplicity, since the further pivot axis thus at the same time also comprises the corresponding detent element and thereby a simple coupling and/or decoupling of leg support and backrest is made possible.

In a further advantageous form of embodiment the detent element is constructed to be manually actuable. With advantage, two detent elements are provided, which are provided laterally at the leg support between leg support and seat element. Advantageously, the pivot axis of the leg support extends through the two detent elements. However, this is not absolutely necessary and represents merely the simplest and most economic form of embodiment.

In the simplest case, the detent elements are constructed in such a way that after detenting of the leg support in the lying position they are releasable by application of pressure force and the decoupling of backrest and leg support can be cancelled. It is, for example, conceivable to provide the detent elements as pushbuttons so that unlocking is possible by application of pressure force and/or application of tension force and the leg support and the backrest are thereby again connectible and movable synchronously together.

In a further advantageous form of embodiment the backrest further comprises a frame element, which advantageously is of U-shaped construction and the limb ends of which are mounted in such a way that when a backrest is pivoted from the seating position to the lying position and conversely these are guided at least in part arcuately. With advantage, in that case the frame structure at the upper free end of the backrest is fixedly arranged thereat and here forms the base of the U-shape. The limbs, which are spaced apart by this base, extend laterally obliquely downwardly in the direction of the seat element. The frame structure stabilises the backrest and the course of movement thereof. The free limb ends are mounted in such a manner that bringing the backrest into the lying position deflects the limb ends in such a way that the deflection path thereof describes a section of an arc. Advantageously, the theoretical fully spread arc has, as centre point, the direct pivot axis and/or the lever axis.

In an advantageous form of embodiment the free ends of the limbs are further arranged to be guided at and/or at least partly in boundary elements. The boundary elements are advantageously arranged laterally of the seat element and extend upwardly in vertical direction. It has proved to be of advantage if the boundary elements are constructed as a segment of a circle, wherein each boundary element advantageously has at least one recess or opening which is arcuate and in which at least in part the free ends of the limbs of the frame element are mounted for guidance. The recess ensures reliable and permanent guidance of the limb ends. In a simplest form of embodiment the recess or opening is formed uniformly, without projections or grooves.

This is obviously to be understood as non-limiting, so that in an advantageous form of embodiment it has additionally proved advantageous for the recess or opening to have a stepped profile. The stepped profile advantageously has two—even more advantageously three—steps. In addition thereto, the limb ends are advantageously formed in such a way that these have at least one projection which can be arranged at least partly, advantageously entirely, within the recess or opening. This projection of the limb ends enters into a mechanically positive and/or frictional couple with the individual steps of the stepped profile so that the position of the backrest is thereby correspondingly settable in dependence on the step number. It is thus conceivable, for example, that for bringing the backrest into the lying position the frame structure is advantageously lifted in the region of its free ends by a pulling force so that the mechanically positive and/or frictional couple between projection and first step is cancelled. If merely two steps are provided, then the first step defines the seating position and the second step the lying position. In particular, the second and last step is advantageous as a stop step, since at the same time it securely and reliably limits the movement path of the backrest. Further arcuate movement beyond this stop step is not possible.

If, on the other hand, the leg support is left in the lying position and merely the backrest is erected again then the stepped profile also proves advantageous here, since through the mechanically positive and/or frictional couple between step and projection the backrest can be held in the predetermined position even though the at least one telescopic connecting element equally exerts a degree of tension force in the opposite direction. Apart from the recesses or openings described here, guide grooves in which the limb ends are appropriately mounted and can be guided are also conceivable.

Moreover, it is conceivable for the seat to additionally comprise a sunshade which is advantageously arranged directly and/or indirectly at the frame element of the backrest and which is guided at least in part arcuately when the backrest is pivoted. All conceivable materials which withstand light and ultraviolet radiation are usable as a sunshade.

Moreover, it is conceivable for the leg support to additionally comprise a foot support which is formed to be adjustable in length direction of the seat. Advantageously, the foot support is of at least partly bowl-shaped construction so that the heels of the child are received by this bowl shape and thus enable comfortable seating. In addition, this foot support, which is formed at the free end thereof to be curved in bowl shape, has a safety function, since this upwardly open bowl shape prevents the child from slipping out of the seat when lying. The bowl-shaped foot support thus forms a limitation against slipping out of the seat. It is conceivable for the foot support to be of plastics material, which can be easily washed and cleaned.

Depending on the size of the child it has additionally proved advantageous to construct the foot support to be appropriately adjustable in height, for example by means of guide grooves or detent elements, so that sufficient security is always guaranteed regardless of the size of the child.

Further advantageous forms of embodiment are evident from the accompanying drawings, in which:

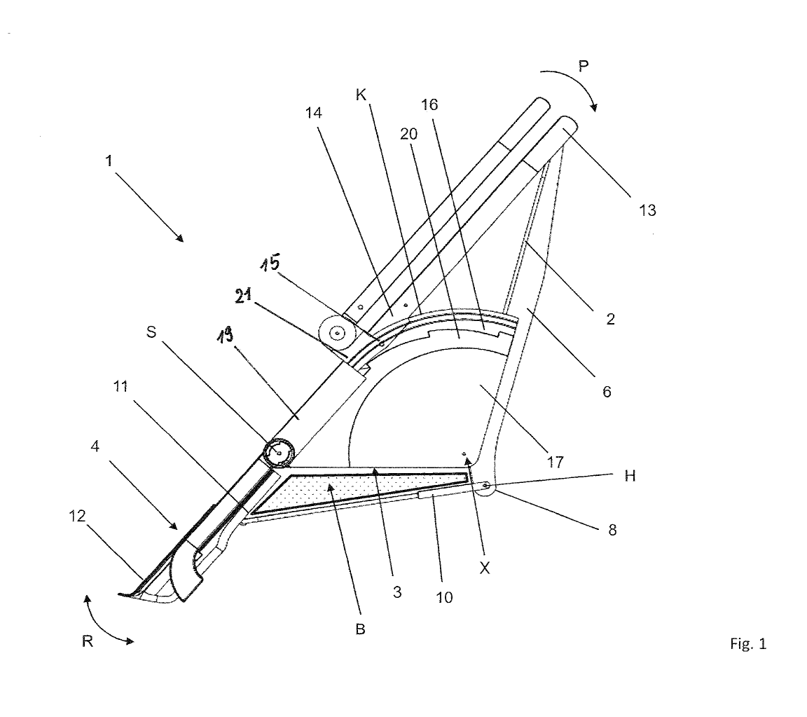

FIG. 1 shows a side view of a seat in a seating position;

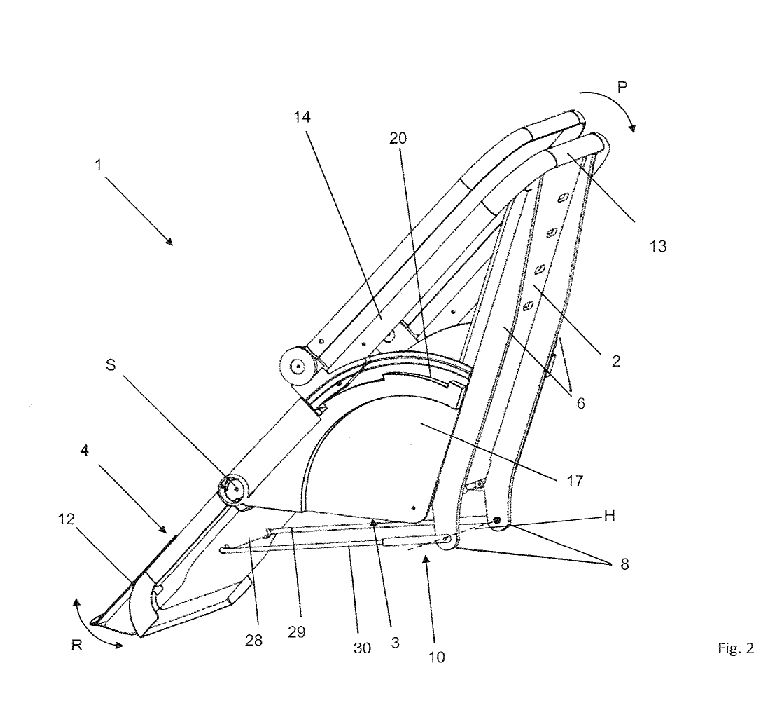

FIG. 2 shows the side view of the seat of FIG. 1 in perspective illustration;

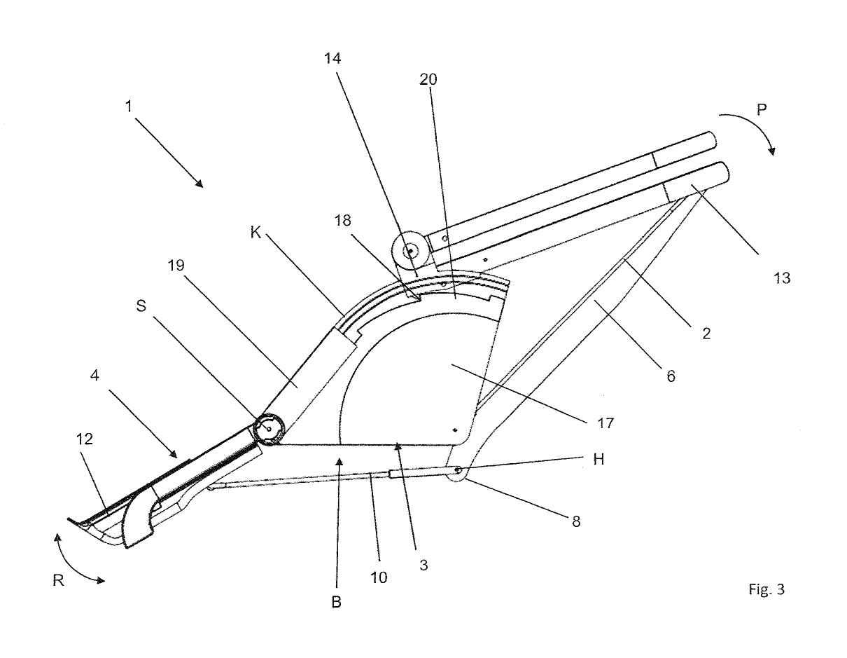

FIG. 3 shows a seat in a side illustration in an intermediate position;

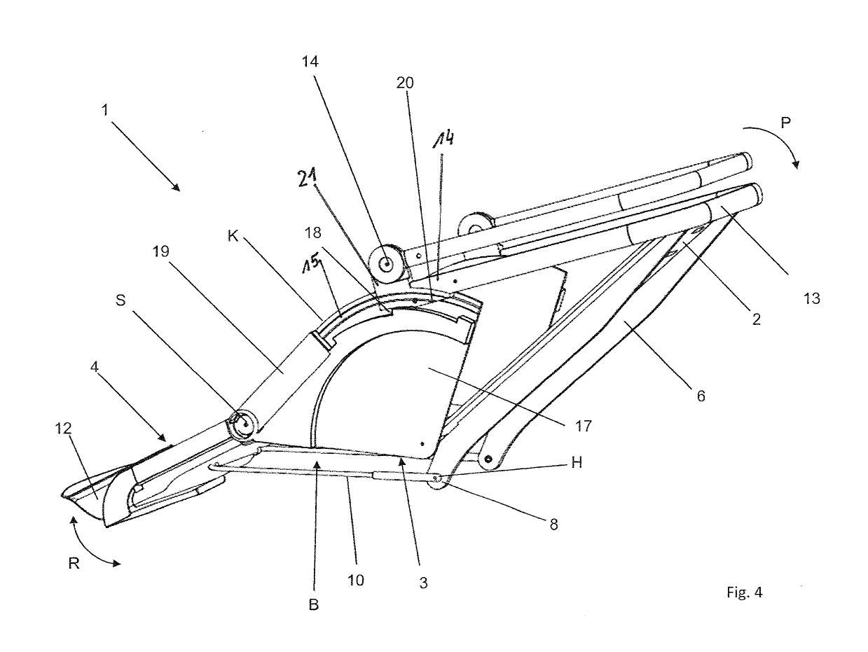

FIG. 4 shows the side view of the seat of FIG. 3 in a perspective illustration;

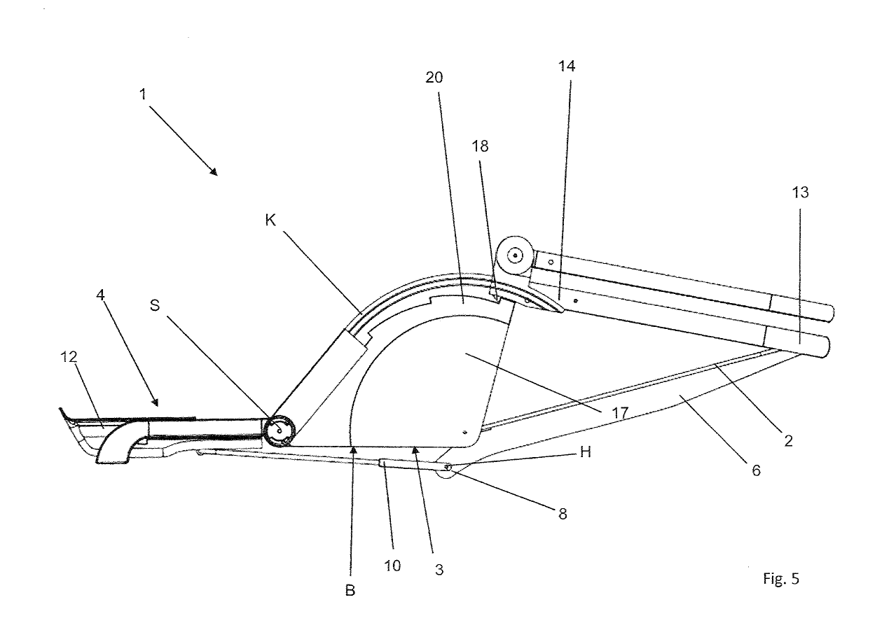

FIG. 5 shows a side view of the seat in the lying position;

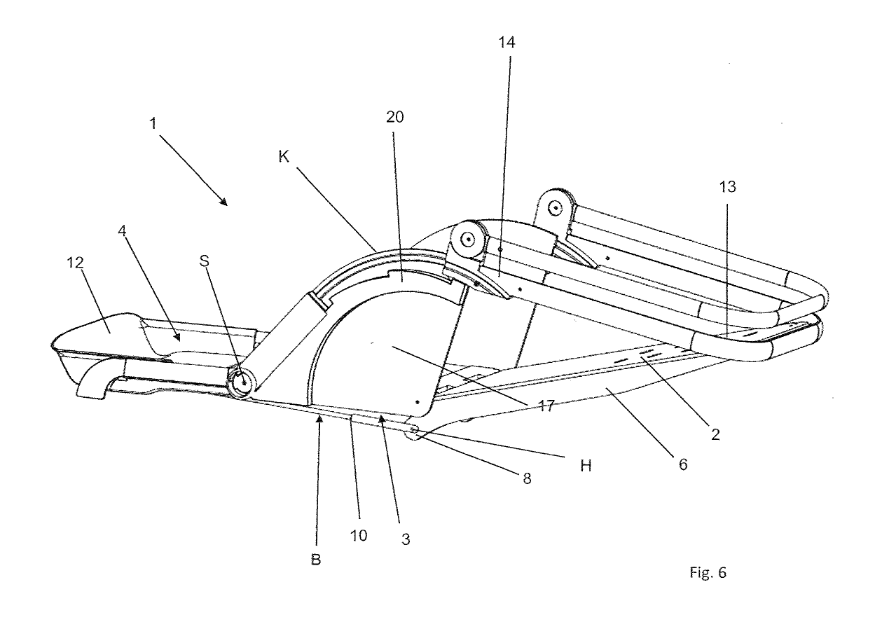

FIG. 6 shows the side view of the seat of FIG. 5 in a perspective illustration;

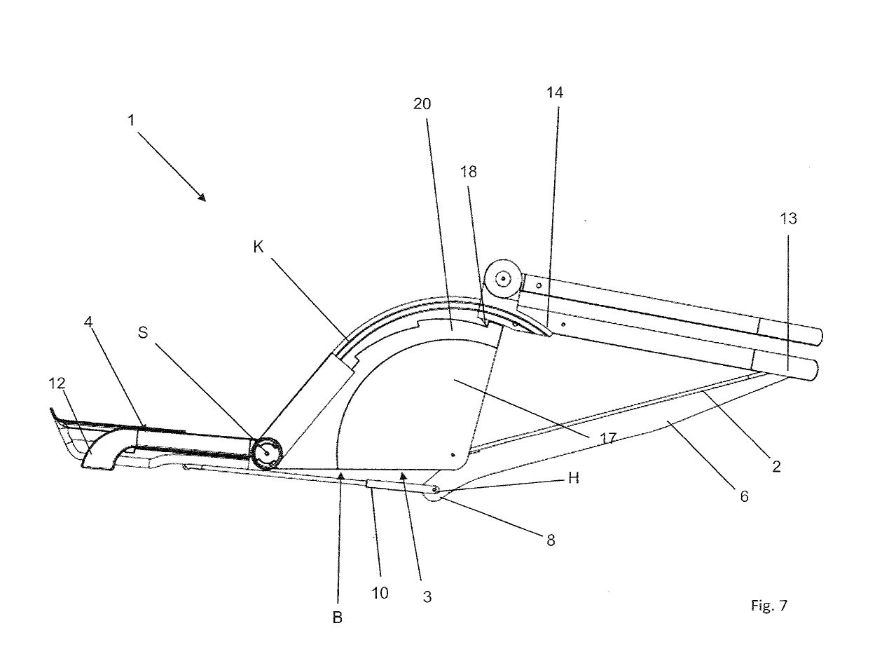

FIG. 7 shows a side view of the seat in a further intermediate position;

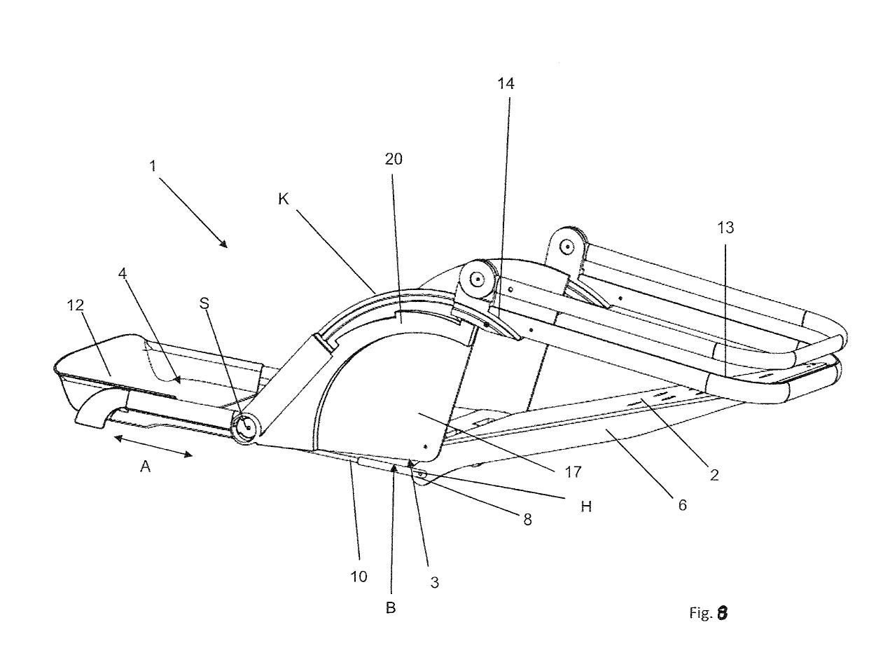

FIG. 8 shows a further side view of the seat in a perspective illustration;

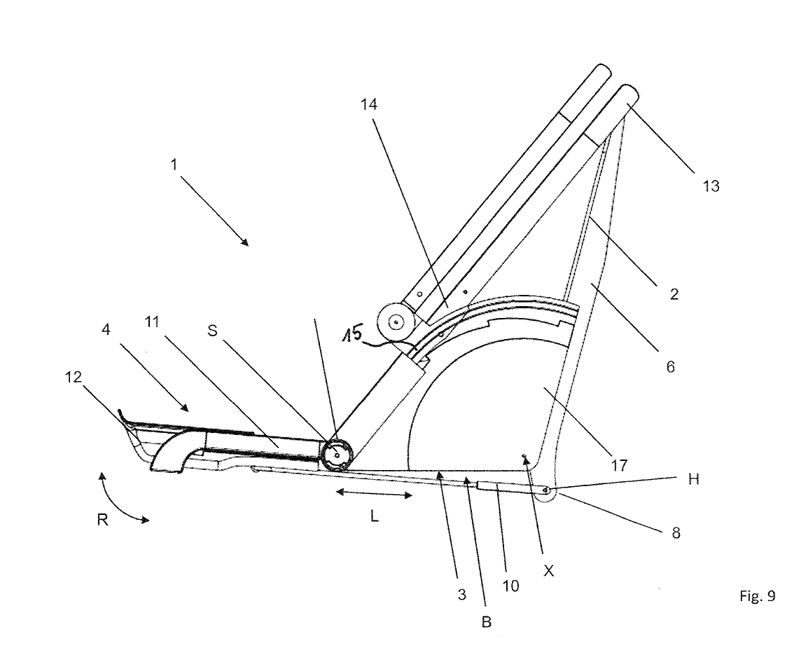

FIG. 9 shows a side view of a seat in a seating position with erected leg support; and

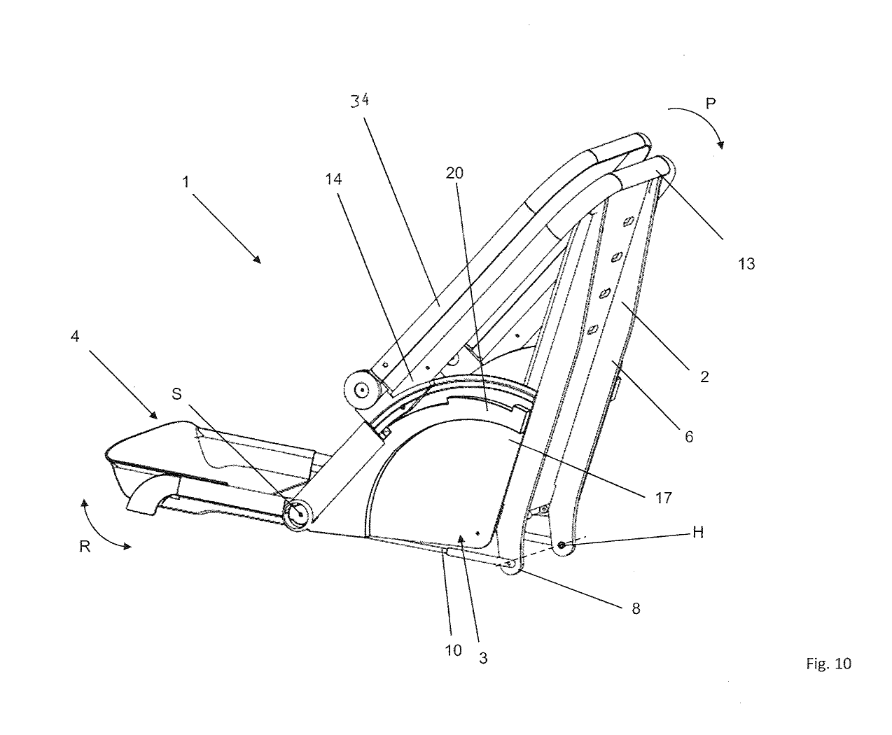

FIG. 10 shows the seat according to FIG. 9 in a perspective view.

The seat 1, which comprises a backrest 2, a seat element 3 and a leg support 4, is shown in FIG. 1. The backrest 2 is illustrated here in seating position, thus in upright position. The backrest is constructed to be pivotable about a first pivot axis X, wherein advantageously during pivotation in arrow direction P the seat element 3 remains at rest and is not deflected therewith. Advantageously, the seat element 3 remains in an unchanged, conveniently horizontal, position as illustrated in FIG. 1 regardless of the position of the backrest 2 or leg support 4.

The leg support 4 is shown here in an inclined seating position. This inclination is particularly comfortable for the seated child. The leg support 4 comprises a frame structure 11 as well as a foot support 12 arranged thereat to be displaceable. The free end of the foot support 12 is of bowl-shaped construction. Pivotation of the leg support 4 in arrow direction R takes place about the pivot axis S.

A projection 6 is fixedly arranged at the backrest 2 and extends downwardly along the backrest 2 in the longitudinal direction thereof. The projection 6 is formed to be longer than the backrest 2 and extends downwardly beyond the end thereof. The free end 8 of the projection 6 is illustrated to be projecting. As a result, an extension of the backrest 2 and thus also an extended lever action arises.

The telescopic connecting element 10 of multi-part construction is advantageously rotatably arranged at this free end 8 of the projection 6.

The backrest 2 additionally comprises a frame element 13, the limbs 14 of which are oriented to be inclined downwardly in the direction of the seat element 3. The ends of the limbs 14 are pivotably mounted on a bearing slide 21, which can be displaced in a gate guide 15 having the form of a segment of a circle. The ends of the limbs 14 are guided in a recess 16 of the boundary element 17. In addition, the ends of the limbs 14 advantageously have at least one nose-like projection 18 which is mechanically positively and/or frictionally coupled with the stepped profile 20 of the recess 16. In this example, the stepped profile 20 is of triple-stepped construction so that the backrest 2 apart from the seating position illustrated here can be brought via an intermediate position (FIG. 4) into the lying position (FIG. 6). Through use of the bearing slide 21 with the frame element 13 it is possible for the backrest 2 to be adjusted in angle of inclination by displacement of the bearing slide in the gate 15. The backrest in that case bears against the inner side of the frame element 13. Instead of this solution, a backrest can also be mounted in classic manner, i.e. pivotably attached to the seat element 3 by way of a detent bearing. Then a bracket of a roof or sunshade can also be fastened to the bearing slide 21.

If the backrest 2 in the seating position is subjected to application of a pressure force downwardly in arrow direction P, for example by raising the limb ends 14 and releasing the locking between projection 18 and stepped profile 20, then several movement sequences advantageously take place synchronously, thus simultaneously. Initially, the limb ends 18 describe at least partly an arc K within the recess 16. The backrest 2 is thereby pivoted about the pivot axis X thereof and the lever axis H upstream of the pivot axis X is guided in the direction of the seat element 3.

By virtue of this displacement of the lever axis H the telescopic connecting element 10 is guided towards the leg support 4 so that this is deflected upwardly in arrow direction R about the pivot axis S thereof. During this movement sequence the connecting element 10 remains unchanged in its length, but is guided in the direction of the seat element 3 so that the region B or the spacing between seat element 3 and connecting element 10 reduces. The seat element 3 remains unchanged in its original position.

A perspective illustration of the seat already described in FIG. 1 is shown in FIG. 2, so that the same components have the same reference numerals and for the sake of simplicity are not explained again here.

The perspective illustration shows that advantageously two projections 6 are arranged at the backrest 2 and extend downwardly, advantageously parallel to one another, at the outwardly disposed rear side of the backrest 2. The two projections 6 project beyond the backrest 2 so that free ends 8 of the projections 6 are formed.

In addition, it is advantageous to construct the telescopic connecting elements 10 to be detachable at the leg support 4, for example by means of hook-in openings, eyes or other snap mechanisms. This is obviously to be understood as non-limiting, so that it is also conceivable for the telescopic connecting elements 10 to be fixedly connected with, for example glued or welded to, the leg support 4.

The arrangement of two parallel telescopic connecting elements 10 additionally increases stability during the movement transformation and in the end settings of backrest and leg support, in which case the base 28 of the U-shaped connecting part of the connecting element increases the stability of the connecting elements. The two limbs 29 and 30 extend parallel to one another in the direction of the free ends 8 of the projections 6. Through this U-shaped arrangement the force at the time of the movement transformation is better distributed during pivotation of the backrest 2 and thus also facilitates deflection of the leg support 4 by a lower level of force. The lever axis H extends between the free ends 8 of the projections 6.

An intermediate position of the seat 1 is shown in FIG. 3. Here, as well, identical reference numerals correspond with identical components as in the previous figures. In this illustration the backrest 2 is deflected from the substantially vertical seating position shown in FIG. 1, so that the limb ends 14 are guided along the arc K in the recess 16 and the projection 18 forms, together with the second step of the stepped profile 20, a connection by mechanically positive and/or frictional couple.

At the same time, the deflection of the backrest 2 has the consequence that the free ends 8 of the projections 6 are similarly tilted, so that the telescopic connecting elements 10 transfer the prevailing pressure force to the leg support and this is deflected upwardly in arrow direction R about the pivot axis S. At the same time, deflection of the upstream lever axis H in the direction of the seat element 3 also takes place so that the region B below the seat element 3 and the connecting element 10 reduces.

A corresponding three-dimensional illustration is shown in FIG. 4, where, in particular, the circular movement along the recesses 16 of the respective element 17 is illustrated. The bearing slide 21 is displaceable by way of the gate guide 15 until it travels against the abutment 19 at the side wall of the seat element 3. The pivot bearing for the roof bracket lies outside the segment path of the side part.

The seat 1 is shown in the lying position in FIG. 5 and FIG. 7, wherein the leg support 4 is advantageously pivoted horizontally (FIG. 5) or at an inclination beyond the horizontal (FIG. 7) about the pivot axis S. The telescopic connecting elements 10 are in that case similarly arranged at an inclination and together with the seat element 3 and the free end 8 span a triangular area.

The backrest 2 is guided substantially planarly in rearward direction and thus offers a comfortable sleeping position for the child (not shown) present in the carriage.

The lever axis H is displaced far below the seat element 3. The projection 18 is locked at the last step so that further pivotation of the backrest 2 is prevented.

The corresponding seat 1 of FIG. 5 is shown in FIG. 6 in a perspective illustration, in which case it is evident here that, in particular, the frame element 13 or the limb ends 14 thereof is or are arranged in an end position at the stepped profile 20, where they act as a limitation for the pivotation.

The corresponding seat 1 of FIG. 7 is shown in a perspective illustration in FIG. 8, wherein it is evident here, in particular, that the frame element 13 or the limb ends 14 thereof is or are disposed in an end position at the stepped profile 20, where they act as a limitation for the pivotation.

FIG. 8 additionally shows the displaceable bowl-shaped foot support 12, which is displaceable in the direction of the arrow A relative to the leg support 4.

Finally, in FIG. 9 there is shown yet a further schematic side view of the seat 1, in which here the backrest 2 and the leg support 4 are illustrated in the decoupled state. In this case, the backrest 2 is arranged in the seating position and not deflected. By contrast thereto, the leg support 4 is disposed—pivoted about the pivot axis S—in the lying position.

This is advantageously made possible by provision of the telescopic connecting elements 10 on the one hand, since these are drawn out and extended in the length thereof, so that pivotation is made possible, in the case of application of tension force which accompanies pivotation of the backrest 2 into the seating position. For additional security the projection 18 engages the steps of the stepped profile in appropriate operative connection.

In addition, a detent element 24 is arranged on the pivot axis S. Advantageously, detent elements 32 of that kind are arranged on either side of the leg support 4. If pressure is now applied to the detent element 32, which in the simplest case is constructed as a pushbutton or as a rocker switch, then the deflection of the leg support into the lying position is released and causes free movement of the leg support 4, which is then returnable to the actual seating position.

During this return to the actual seating position the telescopic connecting elements 10 are loaded with pressure force and are reduced in the length L thereof so that the original initial seating position shown in FIG. 1 is achievable again at any time.

FIG. 10 shows the schematic side view, which is illustrated in FIG. 9, again in perspective, wherein here additionally a sunshade 34 and/or a carrying yoke is or are provided. Advantageously, the two are arranged to be pivotable about a further pivot axis Z.

All features disclosed in the application documents are claimed as significant to the invention insofar as they are new and inventive individually or in combination relative to the prior art.

### REFERENCE NUMERAL LIST

1 seat

2 backrest

3 seat element

4 leg support

6 projection

8 free end

10 telescopic connecting element

11 frame structure

12 foot support

13 frame element

14 limb end

15 gate guide

16 recess/opening

17 boundary element

18 nose-shaped projection

19 abutment

20 stepped profile

21 bearing slide

28 base

29, 30 further limbs

32 detent element

34 sunshade/carrying handle

H lever axis

S pivot axis of leg support

X pivot axis of backrest

Z further pivot axis

R, P pivot direction

L longitudinal direction

B region

K arc

1. A seat, which is constructed to be anchored to, in particular, a pushchair frame and/or doll's pram frame, comprising at least a seat element, a backrest, the inclination of which is formed to be variable along a first pivot axis (X) by way of a pivot mechanism so as to bring the seat from a seating position to a lying position or conversely, and a leg support for supporting the legs, which is pivotably connected with the seat element to be pivotable about a further pivot axis (S), wherein provided between the backrest and leg support is a coupling unit which when the backrest is lowered produces a movement transformation of the leg support in opposite sense synchronously or offset in time and when the backrest is erected restores the leg support to the lower pivot setting or releases it for resetting.

2. The seat according to claim 1, wherein the coupling unit comprises at least one rod-shaped connecting element or a connecting element variable in its length (L), which is arranged to extend below the seat element and is pivotably connected with at least one entrainer at the lower side of the backrest in the region of the pivot axis (X) at the seat element and with at least one entrainer at the lower side of the leg support.

3. The seat according to claim 1, wherein the at least one connecting element variable in its length is of multi-part

4. The seat according to claim 1, wherein the connecting element is constructed to be non-variable in its length (L) when a pressure force is applied to the backrest and/or the connecting element is constructed to be variable in its length (L) when a tension force is applied to the backrest.

5. The seat according to claim 1, wherein the backrest comprises as part of the coupling unit at least one projection which extends in longitudinal direction of the backrest or projects at an angle with respect thereto and protrudes beyond the pivot axis (X).

6. The seat according to claim 5, wherein a free end of the projection co-operates with an end of the connecting element so that an upstream lever axis (H) is thereby formed.

7. The seat according to claim 6, wherein the lever axis H is arranged below the seat element and/or behind the backrest.

8. The seat according to claim 1, wherein the leg support is constructed to be decoupled from the backrest in the lying position.

9. The seat according to claim 8, wherein the leg support is held in the lying position by way of at least one detent element.

10. The seat according to claim 9, wherein the detent element is arranged on the pivot axis (S).

11. The seat according to claim 9, wherein the at least one detent element is constructed to be manually actuable.

12. The seat according to claim 1, wherein the backrest further comprises a frame element, the limb ends of which are mounted so as to be guided at least in part arcuately when the backrest is pivoted from the seating position to the lying position and conversely.

13. The seat according to claim 12, wherein the seat further comprises lateral boundary elements which at least partly laterally bound the seat element and which each have at least one recess for reception of the limb ends of the frame element.

14. The seat according to claim 13, wherein the recess at least in part has a step profile.

15. The seat according to claim 2, wherein the at least one connecting element variable in its length is of multi-part construction,

16. The seat according to claim 15, wherein the connecting element is constructed to be non-variable in its length (L) when a pressure force is applied to the backrest and/or the connecting element is constructed to be variable in its length (L) when a tension force is applied to the backrest.

17. The seat according to claim 2, wherein the leg support is constructed to be decoupled from the backrest in the lying position.

18. The seat according to claim 3, wherein the leg support is constructed to be decoupled from the backrest in the lying position.

19. The seat according to claim 4, wherein the leg support is constructed to be decoupled from the backrest in the lying position.

20. The seat according to claim 1, wherein the leg support is constructed to be decoupled from the backrest in the lying position.
